(19) United States
(12) Patent Application Publication
(10) Pub. No.: US 2013/0197964 A1
(43) Pub. Date: Aug. 1, 2013

(54) METHOD OF MASS MANUFACTURING, MAINTAINING, REPAIRING, SELLING, FINANCING, AND DELIVERING LOW-COST AND LONG-LIFE PASSENGER MOTOR VEHICLES

(71) Applicant: Thomas Edward Mongan, Tucson, AZ (US)

(72) Inventor: Thomas Edward Mongan, Tucson, AZ (US)

(21) Appl. No.: 13/577,916

(22) PCT Filed: Feb. 9, 2011
(86) PCT No.: PCT/US11/24261

§ 371 Date: Aug. 9, 2012

Related U.S. Application Data
(60) Provisional application No. 61/302,950, filed on Feb. 9, 2010.

(51) Int. Cl. G06Q 10/06

(52) U.S. Cl. CPC G06Q 10/0637
USPC 705/7.28

(57) ABSTRACT

A method of mass manufacturing is provided wherein an assembly (e.g., a passenger vehicle) is manufactured from a plurality of parts. The method comprises the steps of licensing/selecting/auditing engineering firms and independent contractors to mass manufacture the assembly in an efficient manner. Reputable agencies are designated to finance loans having a payback schedule extending substantially over the life of the manufactured assembly. The manufactured assemblies are then delivered to individuals who have obtained financing, preferably without dealer intermediates.

Only a small select percent of the world's population can afford the luxury and convenience of private transportation. And while car ownership is viewed as a status symbol in many cultures, it often has a more crucial role. Specifically, for example, ownership of a passenger motor vehicle is frequently a key employment factor in low-income arenas. Additionally or alternatively, in rural or isolated areas, a passenger motor vehicle can be the only missing link between otherwise available health, educational, social, and/or religious resources. While public transportation has attempted to the fill the gap in some global regions, it is often not practical or possible.

### SUMMARY

A method is provided that allows the luxury and convenience of private transportation at the cost of public transportation. With this method, low cost (e.g., $5000 USD) and long life (e.g., 30+ years) passenger motor vehicles can be engineered, manufactured, financed, and sold to billions of people across the globe. The extended life of the vehicle (in conjunction with competitive servicing arrangements provided over this life) allows long loan amortization periods (e.g., 30+ years) whereby minimal installments are required. This mass-supplying method is equally applicable to other articles of manufacture.

### DRAWINGS

FIG. 0 shows a method of mass manufacturing an assembly (e.g., a passenger-motor vehicle) made from a plurality of parts.

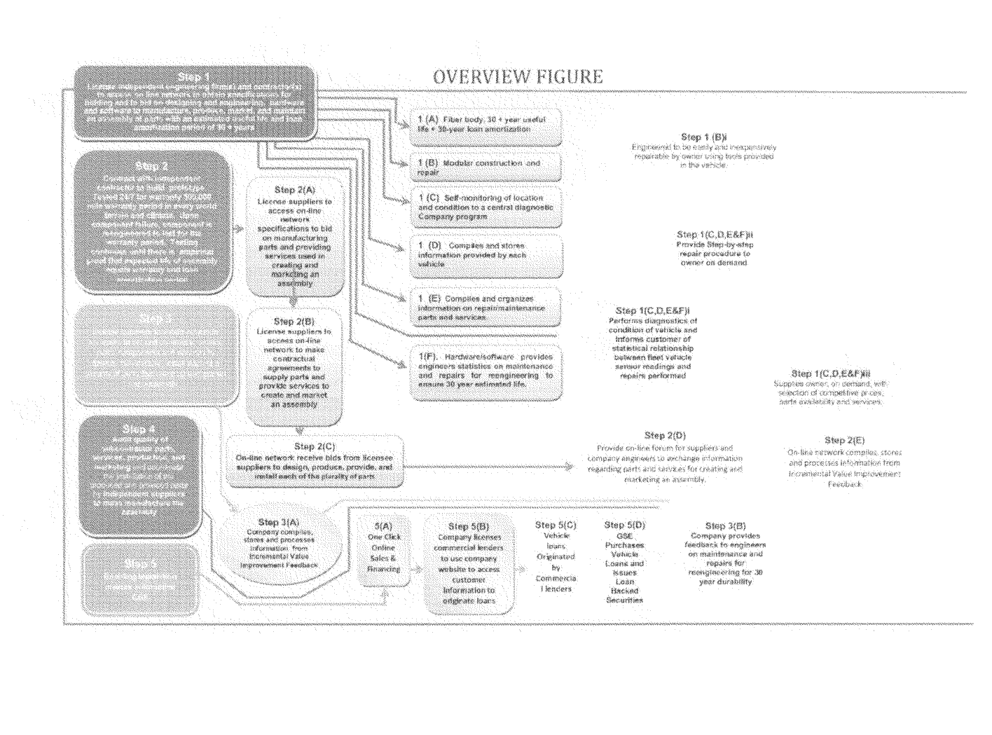

FIG. 1 shows a first step of engineering a prototype assembly.

FIG. 2 shows a second step of building the prototype.

FIG. 3 shows a third step of contracting parts from suppliers for production assemblies.

FIG. 4 shows a fourth step of manufacturing production assemblies.

FIG. 5 shows a fifth step of providing the production assemblies to purchasers.

### DESCRIPTION

Referring now to the drawings, and initially to the Overview Figure, a method of mass manufacturing an assembly (e.g., a passenger motor vehicle) is schematically shown. The result is global marketability with a strategic price of $5000 USD. This translates roughly into a monthly payment of about $36 USD with 20% down and 20% interest.

### Step 1

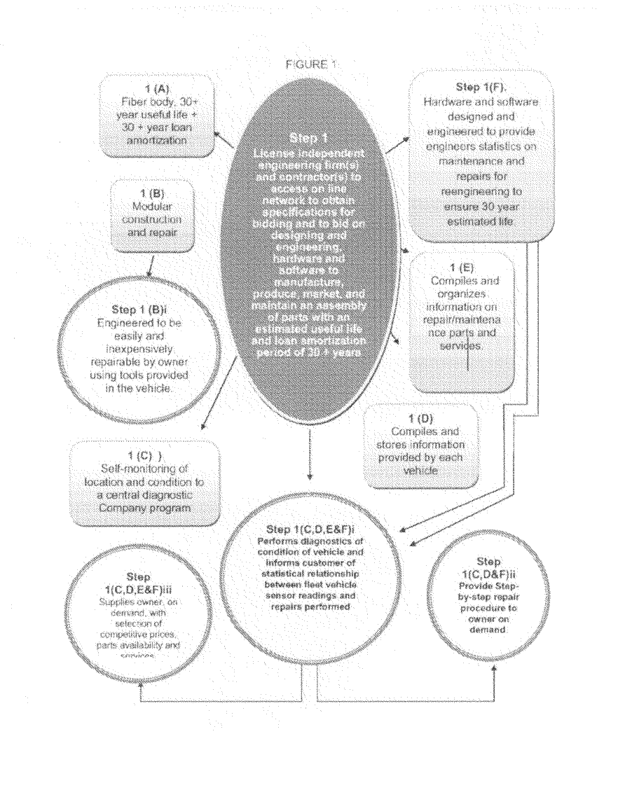

### FIG. 1

The first step of the method involves licensing independent engineering firm(s) and contractor(s) to access an online network to obtain bidding specifications. The firm(s) and/or contractor(s) can then bid on the designing, engineering, hardwaring, and/or softwaring involved in the manufacture, production, marketing and maintenance of the assembly. Licensed firms and contractors can electronically submit proposals to an objective supervisor whereat they can be compiled, compared, and analyzed. This open competition most consistently delivers the highest value to the customer at the lowest price. And it allows a spectrum of vendors, from very small to very large, and from around the world, to evenly partake in the bidding process.

The assembly has certain necessary and desired design factors. With a passenger-motor vehicle, for example, features resulting in the production vehicle having a reasonable purchase price (e.g., less than $10000 USD) and an extended life (e.g., at least 30 years). In other words, the design must allow a consumer purchase price that translates into monthly payments (stretched over the vehicle life) that are in the same range as no-frills public transportation. In the United States, in the current economy, this would be less than $100 USD a month, less than $75 USD a month, less than $50 USD a month, and/or less than $40 USD a month.

The engineered vehicle design factors can include a dependable appearance that conveys a sense of long-term companionship. Vehicles will be sold to people of all ages and marketed around the globe and, moreover, an individual is expected to age 30+ years during an ownership of a single car. Thus, the vehicle appearance can be non-generational, politically-neutral, and culturally integrative geared towards charming our planet, rather than certain small population percentages. Focus groups, surveys, marketing philosophies, psychological principles, and other studies/data can be used to determine (or confirm) that the vehicle's appearance transmits qualities associated with long term relationships.

The vehicle design factors can include a sturdy construction with a life expectancy exceeding (or determining) that of the vehicle itself. A suitable candidate for this construction would be fiber-reinforced composite material. This material can be made to perform sufficiently for 30+ years, it is stronger and lighter than most metals (e.g., steel) used in vehicle framework, it is corrosion resistant, and it is fatigue fighting. Composites also have the advantage of being economically adapted for mass production, thereby contributing to the low-vehicle-cost factor.

Further design factors can include a modular architecture that allows modular assembly, repair, and maintenance. In other words, the auto parts (especially those expected to be periodically replaced), should comprise separate modules that can be rearranged, replaced, combined, or interchanged easily. Such modularity allows standardization of parts and services, both during the production phase and the maintenance phase of the vehicle's life.

The design can also include a self-contained set of repair tools for each vehicle. These tools would enable each vehicle owner (with the help of step-by-step directions shown on the display device) to perform his/her own repairs and maintenance. This ability keeps car-ownership costs down, increases the chance of timely maintenance, empowers car owners, and promotes pride in the vehicle.

The design factors for the passenger-motor-vehicle can additionally include a monitoring device, a reporting device, and a display device. The monitoring device can monitor conditions of the car (e.g., engine hours, electrical system exceptions, mileage, oil temperature, exhaust temperature, transmission temperature, cylinder head temperature, tire pressure, outside temperature, engine vacuum, etc.) its location, and other significant information. This information can be conveyed by the reporting device to the objective supervisor whereat it is stored, compiled, organized, and diagnosed. The display device provides pertinent vehicle-upkeep advice (e.g., maintenance, repairs, etc.) conveyed from the objective supervisor by the reporting device. This design will result in a multitude of vehicles reporting to the same objective supervisor whereby trends can be tracked, problems predicted, and preemptive actions taken.

To minimize depreciation and maximize value, an initiative can be adopted to preclude model or style changes, thereby justifying an extended, comprehensive, and thorough design period. Vehicle parts can be improved (if and when improvements are discovered), but only if they can incorporated into the overall vehicle design without effecting companion components.

### Step 2

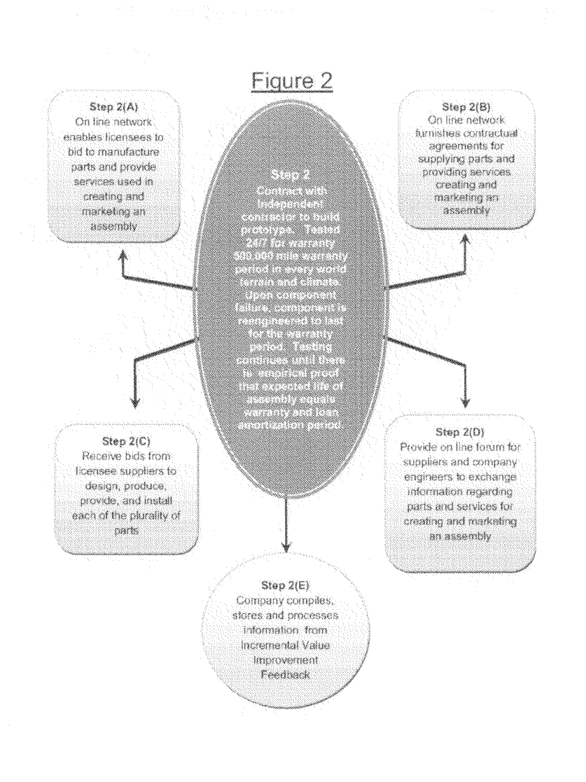

### FIG. 2

The second step comprises contracting with an independent contractor to build the prototype. An online network enables licensed contractors to bid to manufacture parts and provide services used in creating and marketing the assembly. An online network can also furnish contractual agreements for supplying parts, providing services, creating the assembly, and/or marketing the assembly. The bids can also be received online from the licensee supplies to design, produce, provide, and install each of the plurality of parts. An online forum can also provide a place for suppliers and engineers to exchange information regarding parts and services for creating and marketing an assembly.

This step can comprise building and testing one or more prototypes (and preferably at least 10, at least 20, at least 30, at least 40, and/or at least 50 prototypes). With passenger vehicles, for example, the prototypes are tested in every world terrain and climate for at least 200,000, at least 300,000, at least 400,000, at least 500,000, and/or at least 600,000 miles. The prototype-construction team and/or the prototype-testing steam reports improvement suggestions to the engineering firm for revision, and finalization, of the design. Feedback can be additionally or alternatively supplied by each prototype's monitoring and reporting device. An automated system for soliciting, receiving, and monitoring analyzing feedback can be provided. The company can compile, store, and process information from incremental value improvement feedback.

### Step 3

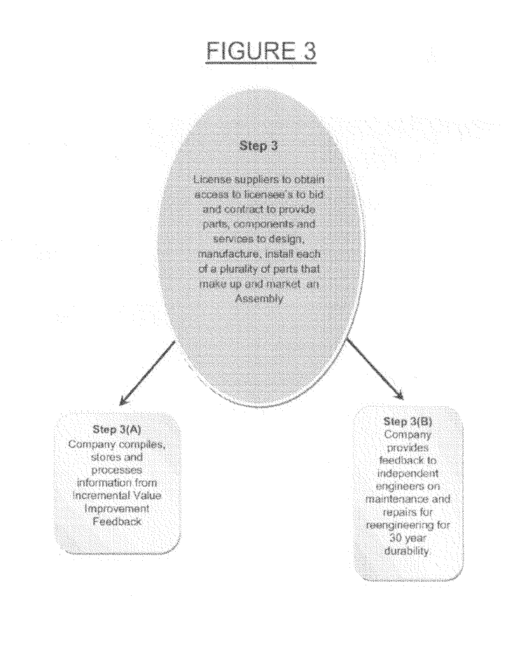

### FIG. 3

Once prototype testing is completed, and the assembly's production design is finalized, licensed suppliers obtain access to bid and contract to provide parts, components and services to design, manufacture and install each of the plurality of parts of the assembly. The company complies and stores and processes information from incremental value improvement feedback. And the company provides feedback to engineers on maintenance and repairs for reengineering the 30 year durability.

### Step 4

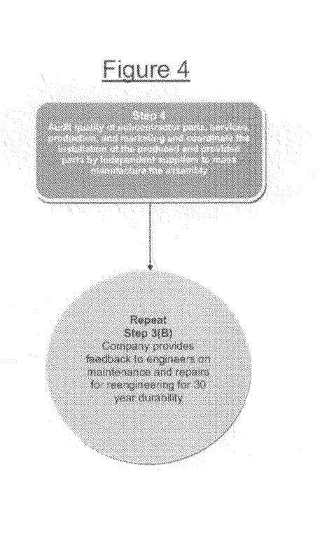

### FIG. 4

In this step, subcontractors' services are audited, and the installation of the plurality of parts is coordinate. Such subcontractors can be selected through an open bidding process coordinate by an objective supervisor, similar to that used to select the engineering firm. A plurality of subcontractors could be selected so as to be accessible in different regions of the world.

It is envisioned that particular parts and specific services will be provided by a plurality of suppliers (to encourage participation by small businesses unable to provide the entire number of parts). Current car constructions quickly become obsolete and replaced with updated models and this causes the corollary outdating of capital cost equipment necessary to manufacture original and replacement parts, compile subassemblies, perform repairs, and carryout periodic maintenance. With modular standardization features, the opportunity for small business participation dramatically increases as equipment investments are guaranteed a payoff period at least equal to vehicle life.

The assembly plant design shown in the last figure can be used on the manufacturing line. Each rectangle in this figure is a separate deeded assembly building, with common walls that is owned or leased by the subcontractor installing a separate part or module. The legs are access roads to the facility that connect with public roads. Each separate assembly unit has its own exclusive access road. Each owner provides their own security. The Company Coordinates assembly and licenses each subcontractor to install each part or module.

### Step 5

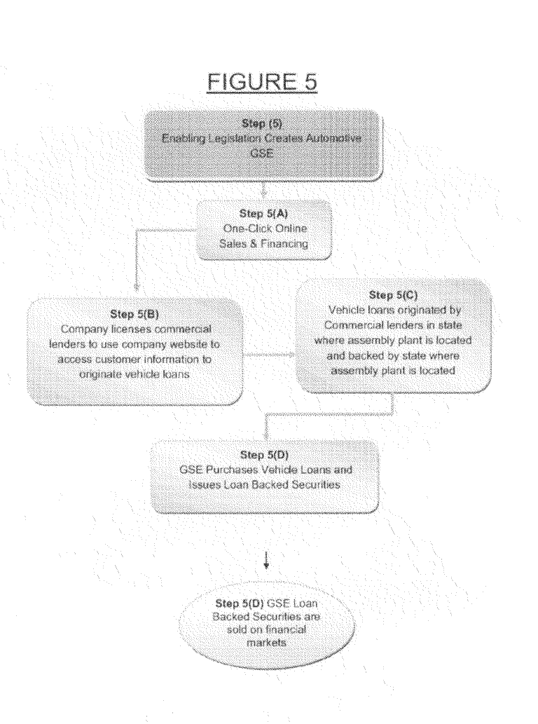

### FIG. 5

Another step in the method involves designating agencies to finance the production with loans having a payback schedule extending substantially over the long life of the vehicle. The company could provide on-click online sales and financing on its website. Commercial lenders could be licensed by the company to access customer information to originate loans. For example, vehicle loans could be originated by commercial lenders in state where assembly plant is located and backed by state where assembly plant is located.

If enabling legislation creates a Government Subsidized Enterprise (GSE), the GSE could purchase vehicle loans and issue loan backed securities. These securities could then be sold on financial markets.

### Closing

One many now appreciate that the method provides a means of mass manufacturing that would allow, low cost (e.g., $5000 USD) and long life (e.g., 30+ years) passenger motor vehicles can be engineered, manufactured, financed, and sold to billions of people across the globe.

1. A method of mass manufacturing an assembly made from a plurality of parts, said method comprising the steps of:
licensing independent engineering firms to access an online network to obtain specifications and to submit bids on engineering the assembly so that it has an estimated useful life of 30+ years;
selecting one of the licensed engineering firms, based on submitted bids, and contracting the selected engineering firm to design a prototype of the assembly;
licensing independent contractors to access the online network to obtain specifications and to submit bids on building the prototype; selecting one of the independent contractors, based on submitted bids, and contracting with this contractor to build the prototype;
licensing independent suppliers to obtain access to licensee's to bid and contract to provide parts, components and services to design, manufacture, install each of the plurality of;
auditing quality of the parts, services, production, and marketing and coordinating the installation of the produced and provided parts by the independent suppliers to mass manufacture the assembly;
mass manufacturing the assembly; and
licensing commercial lenders to access customer information to originate loans for the mass-manufactured assembly.

2-3. (canceled)

4. A method of mass manufacturing as set forth in claim 1, wherein at least two contracts are awarded to two distinct independent contractors for each of the plurality of parts.

5. A method of mass manufacturing as set forth in claim 1, wherein said contract-awarding step is based on a set of criteria, and this criteria includes the distance from the performance location of the installation-coordinating steps.

6. A method of mass manufacturing as set forth in claim 1, wherein the assembly has an expected life and warranty of at least twenty years.

7-10. (canceled)

11. A method of mass manufacturing as set forth in claim 1, wherein the independent contractors design the parts.

12. A method of mass manufacturing as set forth in claim 1, wherein no employees are engaged in installation steps.

13. (canceled)

14. A method of mass manufacturing as set forth in claim 1, wherein the contract awarded to each independent contractor covers a quantity of at least a million parts and extends over a period of at least two years.

15-21. (canceled)

22. A method of mass manufacturing as set forth in claim 1, wherein the contract awarded to an independent contractor guarantees design consistency for at least five years.

23-24. (canceled)

25. A method as set forth in claim 1, wherein the assembly has an expected life of at least twenty years and has an amortization cost allowing financing at a monthly rate of less than $100 USD over its expected life; said method further comprising the steps of:
designating agencies to finance loans having a payback schedule extending substantially over the life of the manufactured assembly; and delivering the manufactured assemblies to individuals that have obtained financing.

26-37. (canceled)

38. A method of mass manufacturing as set forth in claim 1, wherein the assembly comprises a motor vehicle.

39. A method of mass manufacturing as set forth in claim 1, wherein the assembly comprises a passenger motor vehicle.

40. A method of mass manufacturing as set forth in claim 1, wherein the assembly comprises a vehicle having an at least 200,000 mile warranty.

41-43. (canceled)

44. A method of mass manufacturing as set forth in claim 1, wherein the assembly has a modular design, has a modular assembly procedure, and/or is compatible with modular repair and maintenance.

45-48. (canceled)

49. A method of mass manufacturing as set forth in claim 1, further comprising the step of licensing service providers to service a sold assembly.

50. A method of mass manufacturing as set forth in claim 1, wherein the assembly includes a self-contained set of repair-and-maintenance tools, and/or accessible repair-and-maintenance instructions.

51-53. (canceled)

54. A method of mass manufacturing as set forth in claim 1, wherein the assembly has a reporting system that reports its location to a central diagnostic software program.

55. A method of mass manufacturing as set forth in claim 1, wherein the assembly has a condition-monitoring system to monitor its condition.

56. A method of mass manufacturing as set forth in claim 1, wherein the reporting system reports the condition of the assembly to a central diagnostic software program.

57. A method of mass manufacturing as set forth in claim 1, wherein an on-line system monitors, records, compiles and stores sensor output from each vehicle and on the entire fleet of vehicles and on the parts and services purchased from the online system and makes this information, in statistical form, to licensee owners in a form that relates to the information reported by an assembly to information reported by the fleet and correlates the relationship between sensor readings and the parts and services purchased.

58. A method of mass manufacturing as set forth in claim 57, wherein the on-line system reports engine hours, electrical system exceptions, mileage, oil temperature, exhaust temperature, transmission temperature, cylinder head temperature, tire pressure, outside temperature, and/or engine vacuum to a central diagnostic software program.

59-70. (canceled)
